(19) United States
(12) Patent Application Publication
(10) Pub. No.: US 2014/0052513 A1
(43) Pub. Date: Feb. 20, 2014

(54) Social Commerce Intelligence Engine

(71) Applicant: SOLAVEI, LLC, Bellevue, WA (US)

(72) Inventors: James P. Ryan, Bellevue, WA (US); Ryan K. Wuerch, Medina, WA (US); Richard Sean Bethune, Sammamish, WA (US)

(73) Assignee: SOLAVEI, LLC, Bellevue, WA (US)

(21) Appl. No.: 13/804,925

(22) Filed: Mar. 14, 2013

Related U.S. Application Data
(60) Provisional application No. 61/684,996, filed on Aug. 20, 2012.

(51) Int. Cl. G06Q 30/02

(52) U.S. Cl. CPC G06Q 30/0255
USPC 705/14.16; 705/14.53; 705/14.25

(57) ABSTRACT

Embodiments of the present disclosure include an intelligence engine implemented in accordance with a social commerce network community. The social commerce network community may include members, merchants, third party providers, or other entities that have agreed to participate in a social commerce network system. The intelligence engine is configured to use member information stored in a member profile to match members with a commercial opportunity.

### PRIORITY APPLICATION(S)

This patent application claims priority filing benefit from U.S. Provisional Patent Application No. 61/684,996, filed Aug. 20, 2012, which is hereby incorporated by reference, in its entirety.

### BACKGROUND

Conventional direct sales models pay commissions based on a percentage of the purchases made by individuals within a member's network. The more products sold within a member's network, the higher the commissions paid to the member. A member's network grows when the member adds direct recruits to the network. Also, the member's network grows when other members within his or her network recruit new members.

A conventional direct sales network therefore has multiple levels. Recruits of recruits are two levels away from the member. Individuals recruited by members two levels away are three levels away from the member, and so forth. Because purchases made anywhere within the network drive additional commissions for the member, members have an incentive to help their recruits sell product and to help their recruits recruit new individuals into the network.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment suitable for implementing an intelligence engine in accordance with embodiments discussed herein.

FIG. 2 illustrates an example member profile used by the intelligence engine in accordance with embodiments discussed herein.

FIG. 3 illustrates example functionality, interactions and/or processes performed by an intelligence engine in accordance with embodiments discussed herein.

FIG. 4 illustrates a block diagram of an example computing system usable to provide an intelligence engine associated with a social commerce platform in accordance with embodiments discussed herein.

FIG. 5 illustrates an example process that matches members who participate in a social commerce community with a commercial opportunity in accordance with embodiments discussed herein.

### DETAILED DESCRIPTION

Embodiments of the present disclosure include an intelligence engine implemented in accordance with a social commerce network community. The social commerce network community may include members, merchants, third party providers, or other entities that have agreed to participate in a social commerce network system. In one example, a social commerce network community may be a community of members who have signed up for a service, such as a mobile phone service, an energy service, a cable service, or other service hosted by the social commerce network system. The members may also participate in both offline and e-commerce activities that involve buying and selling of goods or services, buying electronic media, and so forth. Moreover, the members may have the opportunity to recruit additional members into the social commerce network community. The member's recruited members become part of the member's personal network, and the member may be compensated (e.g., provided with value) based on a number of members (service subscribers) within his or her personal network. The member may also be compensated for the activities of the recruited members in their personal network, such as purchases made by the recruited members. The intelligence engine is configured to use member information stored in a member profile to determine an interest parameter used within the social commerce network community to provide the member with an improved social commerce experience.

In various embodiments, the improved social commerce experience results when the intelligence engine identifies a commercial opportunity based on a member's interest parameters and provides the commercial opportunity to the member (e.g., the intelligence engine customizes a group of commercial opportunities). For example, the commercial opportunities may be a notification, message, offer or advertisement sent to a device of the member (e.g., via email, text message, phone call, etc.) with information regarding product-specific sale offers, merchant-wide sales, liquidation sales, merchant coupons, merchant discounts, merchant promotions, a new product in stock, recently released product or service, a location based visit for a mobile merchant, a location based visit for an entity within the entertainment industry (e.g., band/artist concert, a Broadway play, a sports team or a game, etc.), or any other commercial information that may be of interest to the member based on the information provided in the member profile.

In various embodiments, the improved social commerce experience results when value is provided by the social commerce network system to the member or an account associated with the member's profile in response to member participation in the social commerce network community. For example, the value may be provided as compensation to the member when the member purchases a product or service at a merchant participating in a commercial opportunity within the social commerce network system or when the member sets up and shares a commercial opportunity within the social commerce network community, as further discussed herein. The value may be in the form of cash payments (such as payments deposited to a paycard associated with the member's account), coupons, discounts, special merchant offers, etc.

In various embodiments, the social network commerce system provides members with the ability to set up and share a commercial opportunity with the recruited members in their personal network, or other members in the social network commerce community. For example, a member may determine, using the member profiles discussed herein, an interest level in a particular product or service for a group of members in their personal or extended network. The member may then convey the group interest level in purchasing the particular product or service to multiple different merchants who market the product or service. In return, the multiple different merchants will compete for the group's business, and the price of the product or service will decrease based at least in part on the competition between merchants and the number of members in the group who are interested in purchasing the product or service (i.e., the social network commerce community allows a member to identify a group interest to pool demand and lower prices based on volume purchase). This may be referred to as a reverse auction, and a member may implement this process to receive value based on the number of members he/she recruits to participate in the volume purchase of the product or service.

Thus, value may be provided to the members in response to their own purchases or activities within the social commerce network community, or in response to purchases or activities by other members within the social commerce network community. Consequently, the social commerce network system creates an economic relationship with its customers. This economic relationship provides incentive and motivation for the customers to continue to provide additional information to the member profile and to continue to update the information in the member profile so that they receive customized commercial opportunities which potentially lead to more value received by the member. Moreover, the customers will be motivated to set up and share commercial opportunities with other members when they continue to receive value (e.g., by referring a commercial opportunity to member(s) or initiating a volume purchase for members within the community).

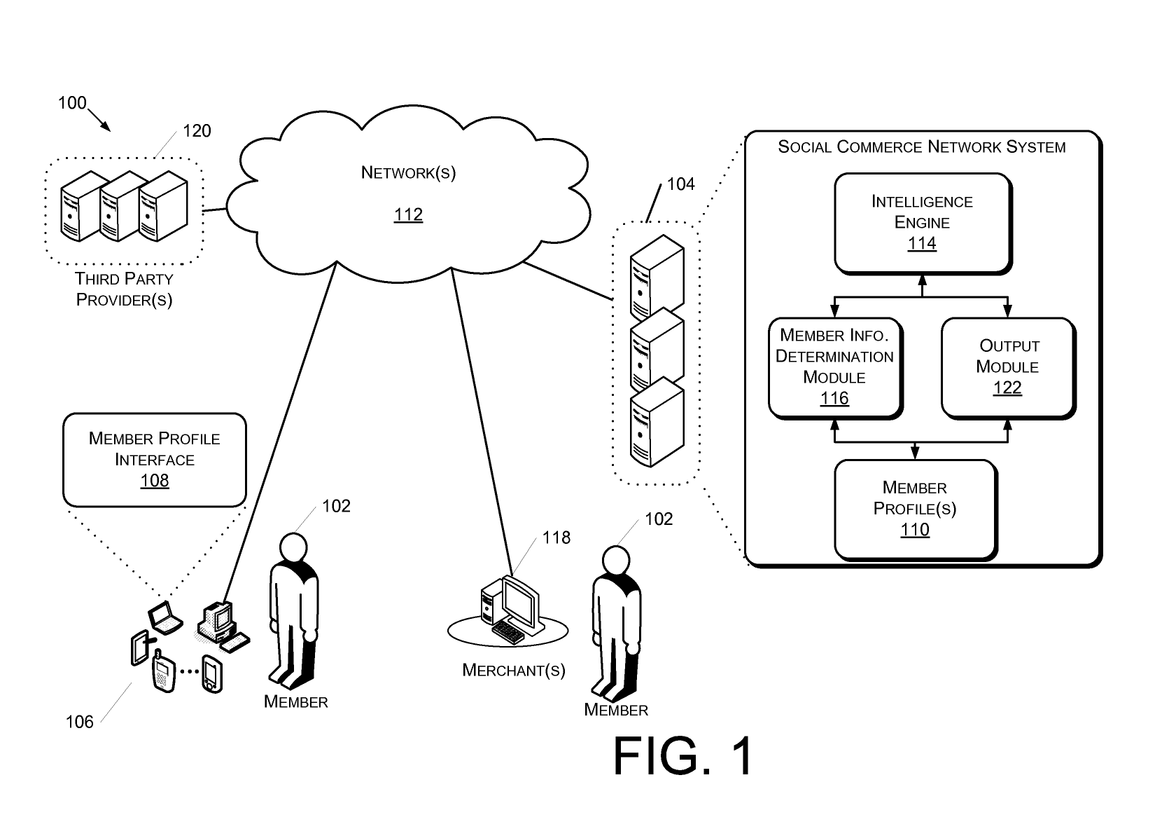

FIG. 1 illustrates an example environment 100 suitable for implementing an intelligence engine in a social commerce network community. Aspects of the environment 100 may be implemented on various suitable computing device types. Suitable computing device or devices may include, or be part of, one or more personal computers, servers, server farms, datacenters, special purpose computers, tablet computers, game consoles, smartphones, media players, combinations of these, or any other computing device(s).

Member 102 is a social commerce participant, and subsequent to signing up with, and agreeing to participate in, a social commerce network system 104, he or she provides information using a client device 106 and a member profile interface 108. The member profile interface 108 allows the member 102 to enter information into a member profile 110 stored at the social commerce network system 104. In various embodiments, the information entered by the member 102 is personal information or commercial preference information explicitly provided, as further discussed herein.

The client device 106 may communicate with the social commerce network system 104 via one or more network(s) 112. The networks 112 may include a local area network (“LAN”), a larger network such as a wide area network (“WAN”), a mobile telephone network (MTN), and/or a collection of networks, such as the Internet. Moreover, the networks 112 may be a wired network, a wireless network, or a combination of both.

The member profile interface 108 may be provided by a web service of the social commerce network system 104. In particular, the client device 106 may include web browsers or other applications that access web-based information via the web service. The web service may provide a number of web and mobile-based tools and information, such as the member profile interface 108, which may facilitate the member's participation in the social commerce network community. For example, the web service may provide web and mobile-based tools that enable the member to view information about their personal or extended network, view a message feed with messages from other members of the community, reach out to prospective members, receive timely information updates about their commercial activities, and so forth. In at least one embodiment, the member profile interface 108 and the member profile 110 are used in conjunction with a merchant portal. The merchant portal provides the member with a customized and personalized social commerce experience (i.e., web-based or mobile-based). Consequently, the members may configure and use their own merchant portal to integrate and display different commercial opportunities recommended by the social commerce network system 104, filter the message feed, communicate with other members in their networks, reach out to prospective members, access available information on other members in their networks, and so forth.

In various embodiments, the social commerce network system 104 includes an intelligence engine 114. The intelligence engine 114 employs a member information determination module 116 to access the information, or a subset of the information, stored in the member profile 110. In some embodiments, the member information determination module 116 may access the member profile 110 and pull member information that is explicitly provided by the member 102 via the member profile interface 108. The member information determination module 116 can then input this information into the intelligence engine 114. In some embodiments, the member information determination module 116 may monitor the member's interactions and behaviors (e.g., purchases, activities, participations, communications, web browsing, etc.) with one or more other members, different merchants 118, or different third party providers 120 in the social commerce network community. The member information determination module 116 may then store the monitored information in the member profile 110 as implicit information, and input this implicit information into the intelligence engine 114.

Once the intelligence engine 114 is provided with member information (e.g., explicit information entered by the member 102 and/or implicit information observed), then the intelligence engine 114 is configured to process the member information and determine one or more interest parameters for the member. The interest parameter represents a member's unique interest in a class or category of commercial opportunities within the social network commerce community.

In various embodiments, the intelligence engine 114 is configured to identify one or more commercial opportunities to provide to the member based on the determined interest parameters. The intelligence engine 114 can then employ an output module 122 to store the interest parameters in the member profile 110 and/or send the identified commercial opportunities to the member 102. Accordingly, the identified commercial opportunities are customized for the member based on the implicit or explicit interest information in the member profile 110.

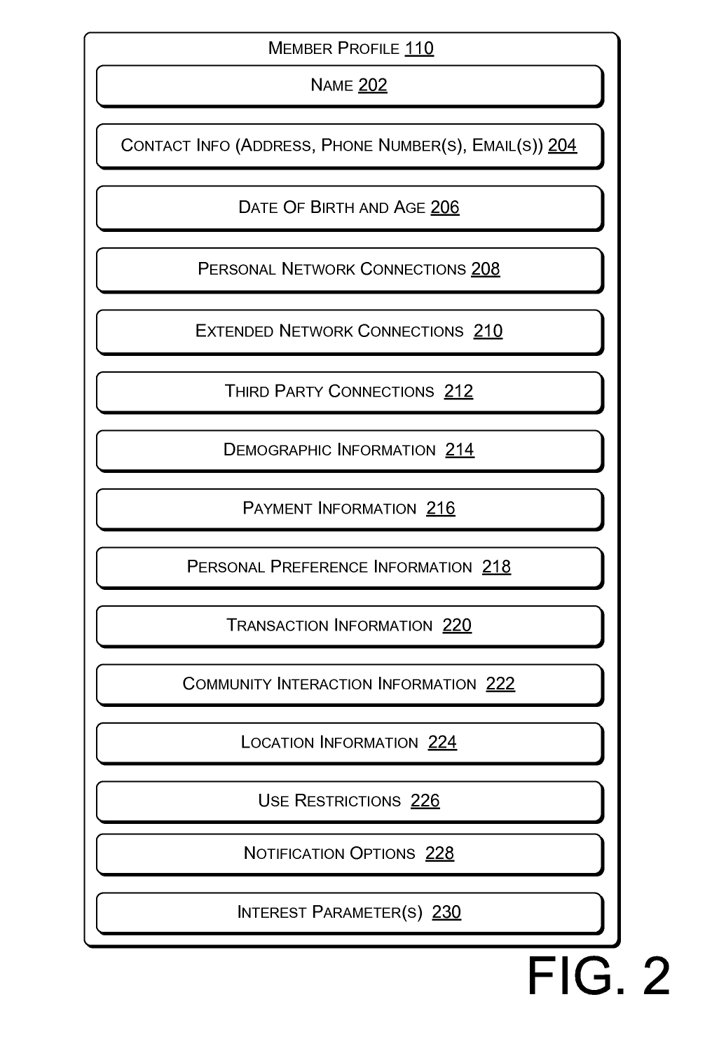

FIG. 2 illustrates example information stored in a member profile 110. Some or all of the example information, along with other information, may be used by the intelligence engine 114 to determine interest parameters for a member and to provide customized commercial opportunities that are likely to be of interest to the member 102.

In various embodiments, the member profile 110 includes personal information such as a name 202, contact information 204 (e.g., address(es), phone number(s), email address(es)), and/or date of birth and age 206.

In various embodiments, the member profile 110 includes social commerce network community information such as personal network connections 208, extended network connections 210, and/or any third party connections 212. As previously discussed, a member's 102 personal network includes other members that were recruited to the social commerce network system by the member 102. In various embodiments, a member's extended network includes those members that are in some way connected to the member 102, but are not one of the member's own recruited members (e.g., a member who is recruited and signed up by one of the original member's recruits). In various embodiments, the third party connections are social network connections (e.g., contacts, friends) for third party social network systems (e.g., Facebook™, Twitter™, LinkedIN™, etc.). Thus, the social network systems may be one of the third party providers 120 in FIG. 1.

In various embodiments, the member profile 110 includes demographic information 214 provided by the member 102. For example, the demographic information 214 may include gender, race, home ownership, employment status, income, profession, number of children or dependents, residence location, disabilities, health issues, etc.

In various embodiments, the member profile 110 includes payment information 216. The payment information 216 specifies a payment type that the member uses to make purchases within the social network commerce community. For example, the payment information may include a registered credit card, a registered bank account, a stored value account, etc.

In various embodiments, the member profile 110 includes personal preference information 218. The personal preference information 218 is a member's explicit feedback provided to indicate interests (e.g., levels, threshold, strength indicators, rankings) that will provide insight into what kind(s) of commercial opportunities the member would like to receive or be made aware. For example, the member may explicitly specify (e.g., indicate a “like”) for general interests or specific interests. A general interest may correspond to a particular merchant category to (e.g., restaurants, recreational activities, sporting goods, entertainment, etc.), types of sports (e.g., soccer, football), types of music (e.g., country, pop, classic rock), types of electronic games, etc. A specific interest may further limit the preferred commercial opportunities compared to the general interests. For example, a specific interest may correspond to particular merchant(s) (e.g., favorite restaurant(s), favorite coffee shop(s)), a specific location for merchants (e.g., the zip code where the member lives), a specific sports team(s) (e.g., the Seattle Seahawks), specific entertainer(s), etc. Thus, the personal preference information 218 is any information that may indicate what the member 102 is interested in or is not interested in so that customized commercial opportunities can better be provided within the social commerce network community. In various embodiments, the social commerce network system 104 can provide to the member 102, via the member profile interface 108, a list or form of general interest and/or specific interests so that the member 102 can provide explicit feedback. For example, the member 102 may check a “like” box or a “dislike” box, the member 102 may provide a more granular percentage indicator (e.g., 10% would be considered low interest, 50% medium interest, and 90% high interest), the member 102 may provide a ranked list, and so forth.

In various embodiments, the member profile 110 includes transaction information 220. The transaction information 220 includes details with respect to purchases made by the member 102 within the social commerce network community. For example, the transaction information 220 may include the goods or services purchased, the quantity, the amount of the purchase, the time of the purchase, the merchant name and category, the merchant location, whether or not a coupon was used, etc. The transaction information 220 may be implied information observed by the member information determination module 116.

In various embodiments, the member profile 110 includes community interaction information 222. The community interaction information 222 includes details associated with any sort of communication or interaction (e.g., direct communications, email, phone call, text message, mobile phone alert, video chat, instant message, simultaneous participation in a commercial opportunity, etc.) or association between the member 102 and any other members in the social network community (e.g., a personal network connection, an extended network connection, or any other member outside the personal network and the extended network, such as social networking contacts). The community interaction information 222 may be implied information observed by the member information determination module 116.

In various embodiments, the member profile 110 includes location information 224. The location information 224 specifies the member location at a given time. For example, the location information 224 may result from a social network check-in at a particular location or may be tied to a GPS tracking of a member's mobile device (or any other tracking technology).

In various embodiments, the member profile 110 includes use restrictions 226 with respect to the information stored in the member profile 110. The use restrictions 226 define how the information in the profile will be used within the social commerce network community. The use restrictions 226 may be selectively defined for individual pieces of information or the use restrictions 226 may be defined for the member profile 110 as a whole. For example, the member 102 may explicitly provide health information with respect to appropriate food consumption habits so that the social commerce network system 104 can provide merchant coupons for restaurants that serve food conducive to the appropriate food consumption habits of the member. However, the member 102 may not want the social commerce network system 104 to use the health information when providing commercial opportunities with respect to a health insurance company participating with the social network commerce system 104. Thus, the member 102 may specify that the health information can be used for restaurant merchant information but not information associated with health insurance.

In various embodiments, the member profile 110 includes notification options 228. The notification options 228 permit a member to specify how the member would like to be informed of commercial opportunities from the intelligence engine 114 or other members in the social commerce network community. For example, the notification options 228 may include timing of delivery of the commercial opportunities (e.g., during the night, during the day, at a particular hour), form of communication (e.g., texts, emails, phone call, etc.), an indication of the amount of information to include in a commercial opportunity (e.g., price, merchant, promotional details), and so forth. The notification options may be defined for particular merchant categories and/or commercial opportunities generated by particular members (e.g., one member may have a higher priority/rank compared to another based on known common interests).

In various embodiments, the member profile 110 includes the determined interest parameters 230. The interest parameters 230 may be referred to as member interest quotient(s) that represent a member's unique interest in a commercial opportunity within the social network commerce community. The interest parameters 230 are determined by the intelligence engine 114. Thus, the interest parameters 230 may be re-determined and updated as the information in the member profile 110 is updated (e.g., more explicit feedback is provided, additional implicit information is monitored, user location is updated, a member indicates a temporary interest such as planning a summer vacation, etc.).

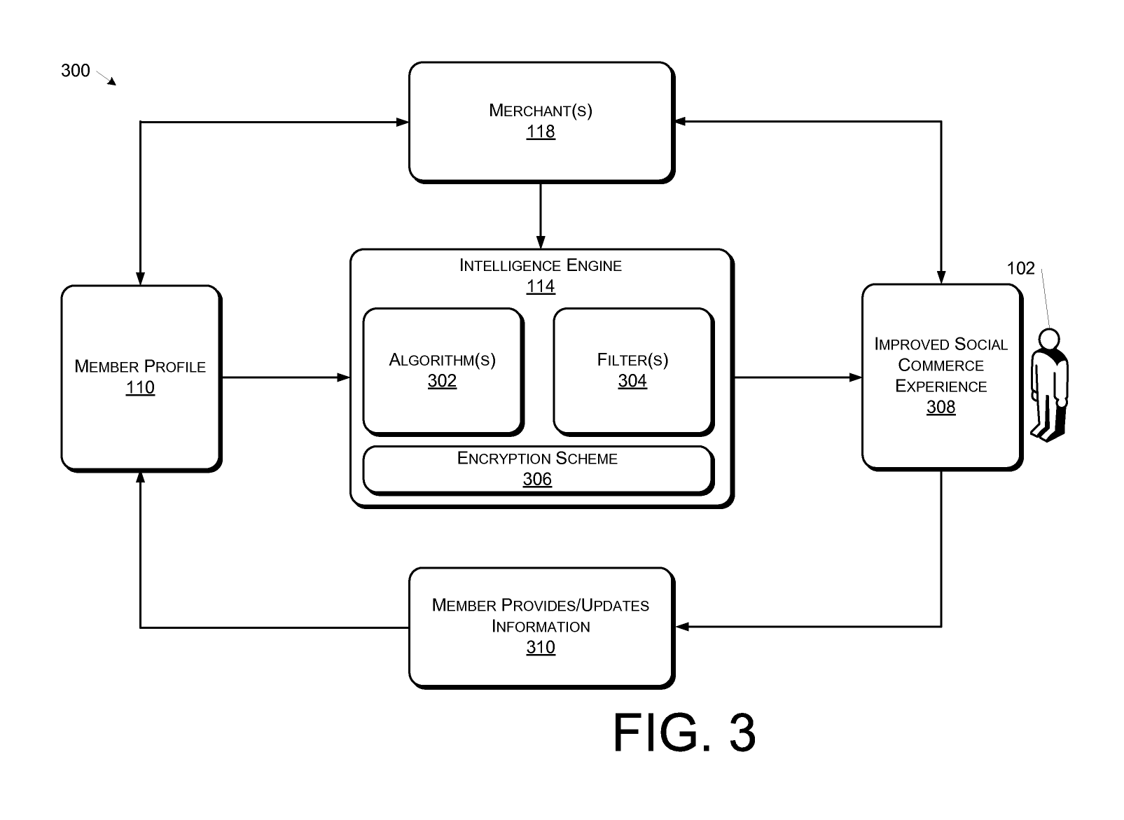

FIG. 3 illustrates example functionality, interactions and/or processes performed in association with the intelligence engine 114.

In various embodiments, the intelligence engine 114 includes one or more algorithms 302 and/or one or more filters 304 that are configured to receive information, or a subset of information, from the member profile 110 via the member profile determination module 116.

In various embodiments, the algorithms 302 are behavior matching algorithms and/or segmenting functions configured to provide real-time customized commercial opportunities to a member based on a behavior trigger tracked by the member information determination module 116. The behavior trigger signals an opportune time for the intelligence engine 114 to provide a commercial opportunity. In at least one example, the member information determination module 116, over time, may determine that a particular member historically buys flowers to be delivered to his wife when he travels for work (e.g., based on the member's participation in the community, the social commerce network system may determine that he is physically outside his usual zip code and is traveling for work). Using this behavior trigger, the intelligence engine 114 can identify one or more commercial opportunities associated with flowers (or alternative gifts) and send them to the member for purchase. In another example, the member information determination module 116 may track that a group of members are attending a sporting event and thus, are in a concentrated area where the sporting event is taking place (e.g., a “heat-map” area determined by the social commerce network system 104 using GPS tracking or check-ins explicitly provided by the members, for example). Based on this determination that an increased number of members are located in a particular “heat-map” area, the intelligence engine 114 may identify a commercial opportunity to distribute and/or recommend to the group of members (e.g., a dinner coupon at a restaurant near the sporting event for the post-game, a merchandise sale for a jersey of the home team, etc.).

In various embodiments, the information received from the member profile 110 and the data associated with the algorithms 302 and the filters 304 may be encrypted using an encryption scheme 306. The encryption scheme 306 is implemented to protect the member profile information so that the member profile information is not known by the social network commerce system 104, and therefore, the social network commerce system 104 cannot share the member profile information with outside advertisers or other entities. This protection establishes an element of trust between the member 102 and the social network commerce system 104 because the member knows that the explicit information provided and the implicit information observed is not going to be sold by the social network commerce system or distributed by the social network commerce system (i.e., enterprise or e-commerce systems often sell off a customer's personal information to advertisers). Consequently, the member 102 is comfortable with providing information to the member profile 110 that she/he may not usually provide in fear of having the information shared or distributed. With access to more personal information via the member profile 110, the social commerce network system 104 can, in return, provide more customized commercial opportunities which will ultimately result in more value to the member.

Thus, using the algorithms 302 and filters 304, the intelligence engine 114 is able to calculate and/or determine the interest parameter(s) 230 based on the information in the member profile 110, thereby providing the member 102 with a more improved social commerce experience 308. In various embodiments, the intelligence engine 114 uses the interest parameters 230 to identify one or more commercial opportunities to send to the member 102 via the output module 122, as previously discussed. Moreover, the commercial opportunities may be implemented by one or more merchants 118 participating in the social network commerce system.

In other embodiments, the commercial opportunities may be set up by another member in the social commerce network community and the other member may be given access to the stored interest parameters 230 of a member 102 in accordance with the use restrictions 226 (e.g., to implement the reverse auction process previously discussed). Accordingly, the other member is able to leverage the accessed interest parameters 230 i) to figure out what the social commerce network community is currently interested in (which is a benefit the member), and/or ii) to show a merchant of the community-wide interest in a particular commercial opportunity (which is a benefit to the merchant). Based on the interest parameters 230 accessed, the other member can set up a commercial opportunity with the merchant and share the commercial opportunity with members in his/her personal network, extended network, or the whole social commerce network community.

According to one example, the other member may query the social commerce network system 104 and the member profiles 110 to determine who has an interest for a coupon for pizza-and-beer in a particular zip code. Even further, the intelligence engine 114 may have determined an interest parameter for a good timing of the pizza-and-beer coupon (e.g., a particular weekend when a local sports team is playing in an important game on television).

As previously discussed, since the member 102 is provided with an improved social commerce experience 308 (e.g., customized commercial opportunities, value, ability to access others' interest parameters and set up a commercial opportunity with a merchant for members of the social commerce network system), then the member is more likely to be motivated to provide additional information to the member profile 110 or to update the information in the member profile 110 at 310.

### Example Computing System

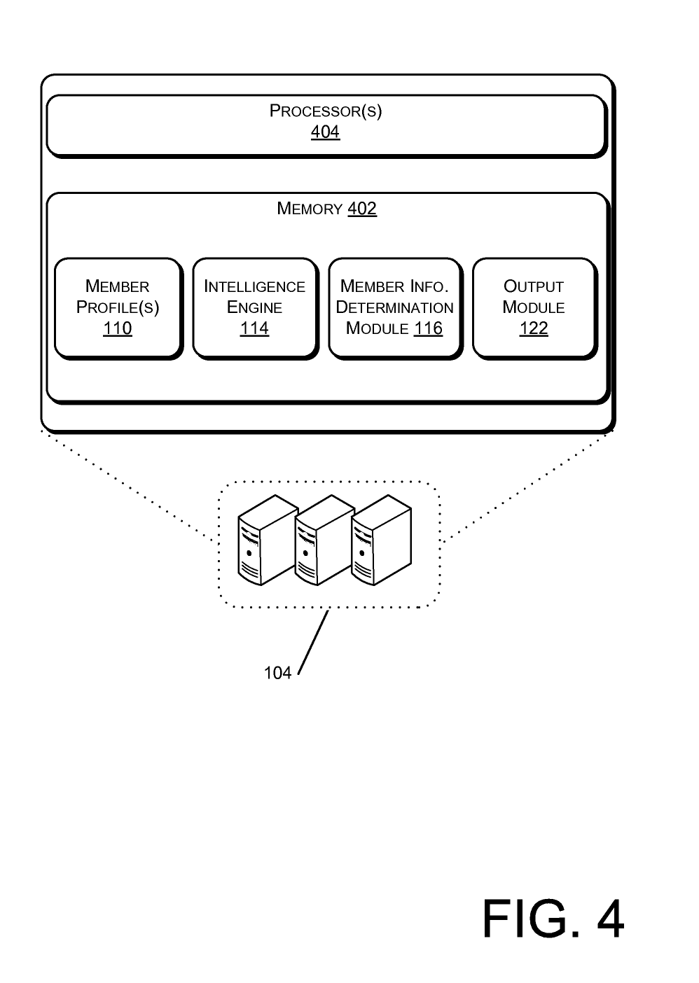

FIG. 4 is a block diagram of an example computing system usable to provide a social network commerce system. The computing system may be configured as any suitable computing device or computing devices capable of implementing the intelligence engine. According to various non-limiting examples, suitable computing devices may include or be part of personal computers (PCs), servers, server farms, datacenters, special purpose computers, tablet computers, game consoles, smartphones, media players, combinations of these, or any other computing device(s).

Memory 402 may store program instructions that are loadable and executable on the processor(s) 404, as well as data generated during execution of, and/or usable in conjunction with, these programs. For example, the memory 402 includes the member profile(s) 110, the intelligence engine 114, the member information determination module 116, and the output module 122.

### Computer-Readable Media

Depending on the configuration and type of computing device used, memory 402 may include volatile memory (such as random access memory (RAM)) and/or non-volatile memory (such as read-only memory (ROM), flash memory, etc.). Memory 402 may also include additional removable storage and/or non-removable storage including, but not limited to, flash memory, magnetic storage, optical storage, and/or tape storage that may provide non-volatile storage of computer-readable instructions, data structures, program modules, and other data.

Memory 402 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

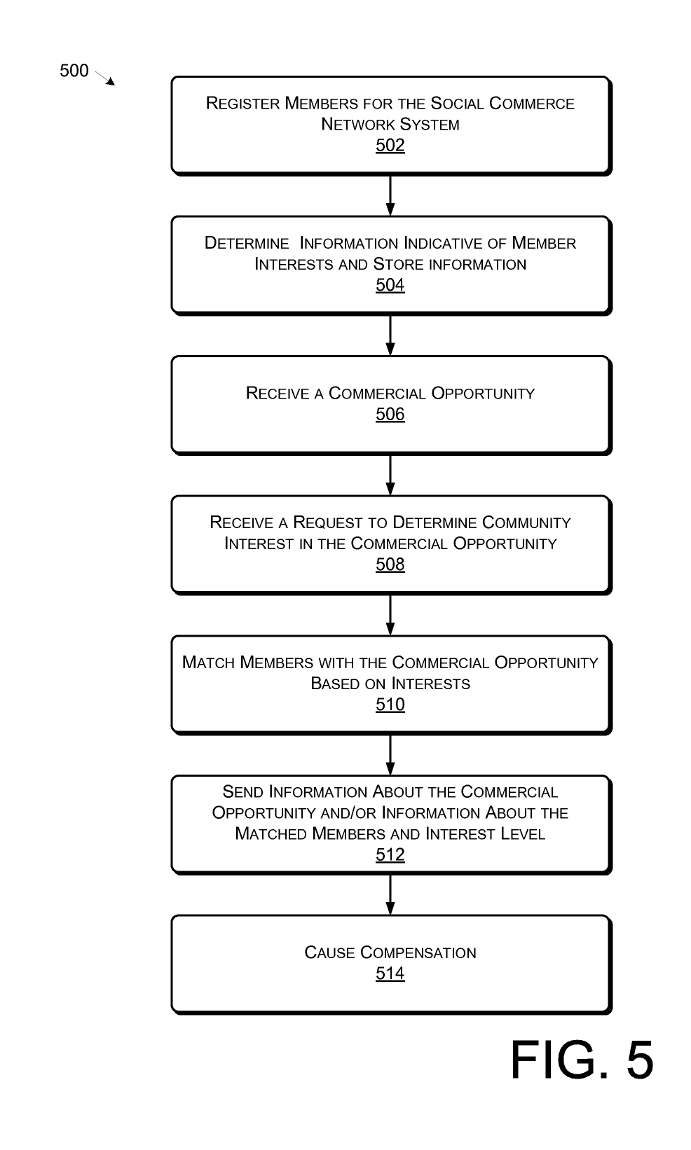

FIG. 5 illustrates an example process 500 for matching members who participate in a social commerce community with a commercial opportunity, based on member interests. The process 500 is illustrated as a collection of blocks in a logical flow chart, which represents a sequence of operations that can be implemented in hardware, software, or a combination thereof In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes in FIG. 5 may be described with reference to FIGS. 1-4.

At block 502, the social commerce network system 104 registers members 102. For example, members 102 may register with, or sign up for, the social commerce network system 104 to receive and participate in commercial opportunities from other member or merchants. In various embodiments, the members 102 may have the opportunity to recruit additional members into the social commerce network community 104. The member's recruits may become part of the member's personal network, and the member may be compensated (e.g., provided with value) based on a number of recruited members (service subscribers) within his or her personal network, and/or their activities within the social commerce network system 104. The member may also be compensated for the activities of the recruited members in their personal network, such as purchases made by the recruited members.

At block 504, the member information determination module 116 of the social commerce network system 104 may determine and store information indicative of one or more interests in a member profile 110, as discussed with respect to FIG. 2. In various embodiments, the information is determined when a member explicitly provides, e.g., via the member profile interface 108, information indicating interests of the members in corresponding member profiles. In other embodiments, the information is determined by tracking member activity within the social commerce network system 104 and/or activities in relation to other third party providers 120. For example, components of the social commerce network system 104 may be configured to track member transactions (e.g., items or services purchased, amount, quantity, timing of transactions, buying or selling, etc.). In another example, components of the social commerce network system 104 may be configured to track member interactions within the social commerce network system 104, or external to the social commerce network system 104 (e.g., with contacts or connections from third party social networks).

At block 506, the intelligence engine 114 may receive information about a commercial opportunity. For example, the information may include a class or category for the commercial opportunity (e.g., a restaurant coupon, a new product sale, game tickets, concert tickets, etc.), as well as timing information for the opportunity and merchant information. In various embodiments, a merchant 118 that participates in to the social commerce network system 104 may set up and provide the commercial opportunity to the intelligence engine 114. In other embodiments, a member of the social commerce network system 104 may interact with a merchant 118 to determine and set up the commercial opportunity. In this scenario, the member may be referred to as an organizing member or sponsoring member who sets up the commercial opportunity and who may be compensated based on a level of member interest or a number of members who participate in the commercial opportunity (e.g., purchase goods or services). Accordingly, a merchant or an organizing member may request that the intelligence engine 114 determine one or more members that are likely interested in the commercial opportunity.

In various embodiments, the organizing member may want to gauge interest in a commercial opportunity before finalizing the commercial opportunity with a merchant 118. Accordingly, at block 508 an organizing member may optionally request that the intelligence engine 114 characterize an interest level for the commerce community. For example, the intelligence engine may identify a number of members that are likely interested in a commercial opportunity (e.g., a number of members that like TEAM A) and/or a number of members that may already have a pre-existing location relationship with a merchant (e.g., members that have already purchased tickets to watch TEAM A in the BIG GAME). To this end the organizing member can show a merchant, such as a restaurant close to the STADIUM where TEAM A will play in the BIG GAME, that a first number of members may be interested in going to the BIG GAME to watch TEAM A and/or that a second number of members have already purchased tickets to the BIG GAME, thereby creating a location relationship with the merchant at a future time. If the organizing member presents the potential strong interest level (e.g., a large community of members that may participate) to the merchant, the merchant may be more likely to provide a generous discount.

A location relationship associates a member with the merchant 118 based on a current, future, or usual physical proximity to a location of the merchant. A member's physical location may be determined by GPS or other tracking technology, social network check-ins, tracked transactions, and so forth. Thus, the location relationship between a member and a merchant may indicate that the member's current physical location is within a predefined distance (e.g., two blocks, one mile, three miles, ten miles, and so forth) or proximity to a location of the merchant. In another example, the location relationship between a member and a merchant may indicate that the member will be within a predefined distance or proximity to a location of the merchant at some point in the future. This may be determined by evaluating a member calendar or schedule information (e.g., an appointment indicating “BIG GAME with son”), as well as transaction information (e.g., the member purchased plane tickets to CITY A for certain dates, or the member purchased game tickets to the BIG GAME in CITY B). In yet another example, the location relationship between a member and a merchant may indicate that the member usually is located within a predefined distance or proximity to a location of the merchant (e.g., a home address, a business address, a known neighborhood, a city, etc. that may be registered in a member profile).

At block 510, the intelligence engine 114 matches members to the commercial opportunity based on the interest information stored in the member profiles (e.g., explicitly provided information, tracked information, etc.). In various embodiments, the intelligence engine 114 may limit the matching to members that are part of a personal network of the organizing member. For example, the personal network may include the members that participate in the social commerce network system 104 as a result of the organizing member's recruiting efforts. This may include members that were recruited by the organizing member or members that were recruited by the organizing member's recruits (e.g., a multi-level direct sales hierarchical structure under the organizing member). In other embodiments, the intelligence engine 114 may match members that are part of a larger network of members (e.g., all members of the social commerce network system 104 regardless of whether they fall within the organizing member's marketing hierarchy). Therefore, the intelligence engine can determine an overall interest level in the commercial opportunity.

At block 512, the output module 122 sends information about the commercial opportunity to the matched members. The output module 122 may also send information about the matched members to the organizing member, or information that characterizes the interest level of the commerce community (e.g., a number of members that have an interest that satisfies a threshold, a number of members that have a location relationship with the merchant, etc.). For example, the information communicated to the matched members may include an offer to purchase goods or services at a discount price. The information communicated to the matched members may also include location information for a merchant 118 offering the commercial opportunity, as well as timing information for when the offer is valid (e.g., an expiration date, a particular day, a particular month, particular hours, etc.).

In various embodiments, the output module 122 may send contact information and identification information of matched members to the organizing member, and the organizing member may then send the commercial opportunity to the matched member (e.g., via a text, email, phone call, etc.). In this scenario, the intelligence engine 114 may ensure that any member information used to determine an interest level, which the member may not want shared with other members, remains private. Therefore, such information may not be communicated to the organizing member. In alternative embodiments, the output module 122 may communicate an overall interest level of the community (e.g., a number of interested members) while maintaining anonymity of the matched members.

In some embodiments, once the intelligence engine 114 matches an initial group of members to a commercial opportunity, the intelligence engine 114 may consider additional information before the output module 122 sends the information about the commercial opportunity. For example, the intelligence engine 114 may only send the information to those members that exhibit a behavior trigger, such as a location relationship with the merchant 118 offering the commercial opportunity.

At block 514, the social commerce network system 104 causes the organizing member to be compensated. For example, the organizing member may be compensated based on a number of members who participate in the commercial opportunity (e.g., purchase a good or service).

### CONCLUSION

Although the disclosure uses language that is specific to structural features and/or methodological acts, the invention is not limited to the specific features or acts described. Rather, the specific features and acts are disclosed as illustrative forms of implementing the invention.

What is claimed is:

1. A method comprising:
storing, for each member in a group of members that have registered to participate in a commerce community, information indicative of one or more interests of the members in corresponding member profiles;
receiving, from a first member in the group, a request to match members in the group to a commercial opportunity;
matching, based on the information indicative of one or more interests of the members stored in the corresponding member profiles, one or more other members in the group to the commercial opportunity; and
based at least on the matching, performing one or more of:
sending information about the commercial opportunity to the one or more other members of the group; and
sending, to the first member in the group, information that characterizes an interest level of one or more other members of the group that are matched to the commercial opportunity.

2. The method of claim 1, wherein the information that characterizes the interest level of the one or more other members of the group maintains anonymity of the one or more other members of the group.

3. The method of claim 1, wherein the information that characterizes the interest level of the one or more other members of the group includes one or more of a number of members that are matched to the commercial opportunity and a number of members that have a local relationship with a merchant entity that provides the commercial opportunity.

4. The method of claim 1, wherein the commercial opportunity comprises an offer to purchase a product or service from a merchant entity.

5. The method of claim 4, further comprising:
receiving an indication that the at least some of the one or more other members in the group have purchased the product or the service from the merchant entity; and
causing the first member to be compensated based at least in part on the purchases made by the one or more other members in the group.

6. The method of claim 4, wherein the commercial opportunity further comprises a purchase discount for the product or the service, and an amount of the purchase discount depends on a number of the one or more other members in the group.

7. The method of claim 6, wherein the purchase discount is applied after the number of the one or more other members purchase the product or the service from the merchant entity.

8. The method of claim 1, wherein the information indicative of the one or more interests comprises previous purchases made within the commerce community.

9. The method of claim 1, wherein the information indicative of the one or more interests comprises information tracked from member communication within the commerce community.

10. The method of claim 1, wherein matching the one or more other members in the group to the commercial opportunity further comprises determining that the one or more other members in the group are physically located within a predefined distance of a location of a merchant entity that provides the commercial opportunity.

11. The method of claim 1, wherein the first member is an organizing member of the group of members, and wherein the group of members comprise a personal network for the organizing member, and wherein the one or more other members in the group of members is directly or indirectly involved in the commerce community as a result of recruitment by the organizing member.

12. A method comprising:
receiving, from a sponsoring member in a network of members that are registered to participate in a commerce community, information about a commercial opportunity offered by a merchant;
determining whether each member in the network of members have an interest in the commercial opportunity based on information stored in a member profile;
identifying one or more members in the network of members that have the interest in the commercial opportunity;
receiving, for at least some of the one or more members, information indicating a location relationship between the at least some of the one or more members and the merchant; and
providing the commercial opportunity to the at least some of the one or more members.

13. The method of claim 12, wherein the sponsoring member sets up the commercial opportunity with the merchant, and the method further comprises causing the sponsoring member to be compensated for setting up the commercial opportunity with the merchant.

14. The method of claim 12, wherein the information indicating the local relationship indicates that the at least some of the one or more members are currently located within a predefined distance to a physical location of the merchant.

15. The method of claim 12, wherein the information indicating the local relationship indicates that the at least some of the one or more members will be located within a predefined distance to a physical location of the merchant at a future time.

16. The method of claim 15, further comprising accessing schedule information to determine that the at least some of the one or more members will be located within the predefined distance to the physical location of the merchant at the future time.

17. The method of claim 15, further comprising accessing electronic transaction information to determine that the at least some of the one or more members will be located within the predefined distance to the physical location of the merchant at the future time.

18. The method of claim 12, wherein the information indicating the local relationship indicates that a member profile for the at least some of the one or more members includes a registered location that is within a predefined distance to a physical location of the merchant.

19. The method of claim 12, wherein the commercial opportunity comprises a purchase discount for a product or service offered by the merchant, and an amount of the purchase discount depends on a number of the at least some of the one or more members for which the information indicates the local relationship with the merchant.

20. A system comprising:
one or more processors;
one or more memories;
a plurality of member profiles, stored in the one or more memories, that contain information indicative of member interests;
an intelligence engine, stored in the one or more memories and operable by the one or more processors, that match, based on an analysis of the information indicative of the member interests, a group of members to a commercial opportunity, the commercial opportunity being set up by a participant in a commerce community; and
an output module, stored in the one or more memories and operable by the one or more processors, that sends information associated with the commercial opportunity to each member in the group of members.

21. The system of claim 20, wherein the participant is a merchant that offers the commercial opportunity.

22. The system of claim 20, wherein the participant is a member of the commerce community and the member receives compensation when members in the group participate in the commercial opportunity.

23. The system of claim 22, wherein the members in the group participate in the commercial opportunity by purchasing a product or service from the merchant that offers the commercial opportunity.

24. The system of claim 20, wherein the intelligence engine matches the group of members to the commercial opportunity by determining that each member in the group is currently within a predefined proximity to a physical location of a merchant that offers the commercial opportunity.

25. The system of claim 20, wherein the intelligence engine matches the group of members to the commercial opportunity based at least in part on previous purchase information stored in a member profile.

26. The system of claim 20, wherein the intelligence engine matches the group of members to the commercial opportunity based at least in part on commerce community interaction information stored in a member profile.

27. One or more computer storage devices storing executable instructions that, when executed on one or more processors, perform operations comprising:
storing, for each member in a group of members that have registered to participate in a commerce community, information indicative of one or more interests of the members in corresponding member profiles;
receiving, from a first member in the group, a request to match members in the group to a commercial opportunity;
matching, based on the information indicative of one or more interests of the members stored in the corresponding member profiles, one or more other members in the group to the commercial opportunity; and
sending, to the first member, contact information and identification information associated with each of the one or more other members.

28. The one or more computer storage devices of claim 27, wherein the contact information and identification information does not include the information indicative of the one or more interests of the one or more other members.
